(19) United States
(12) Patent Application Publication
(10) Pub. No.: US 2007/0291300 A1
(43) Pub. Date: Dec. 20, 2007

(54) Method, System and a Computer Program for Automatically Processing a Job Ticket for a Printing Process

(75) Inventors: Didier Lefebvre, Limal (BE); Jean-Marc Bodart, Louvain-la-Neuve (BE)

Correspondence Address: SCHIFF HARDIN, LLP;PATENT DEPARTMENT, 6600 SEARS TOWER, CHICAGO, IL, 60606-6473, US

(73) Assignee: OCE PRINTING SYSTEMS GMBH, Poing (DE)

(21) Appl. No.: 11/575,776

(22) PCT Filed: Sep. 28, 2005
(86) PCT No.: PCT/EP05/10498

§ 371 Date: Mar. 22, 2007

(30) Foreign Application Priority Data
Sep. 29, 2004 (DE) 10 2004 047 327.7

(51) Int. Cl. G06F 3/12

(52) U.S. Cl. 358/1.15

(57) ABSTRACT

In a method or program for automatic execution of a job ticket for a printing press, the job ticket with a tree structure is imported in which at least one intent node is contained, the intent node having at least one template name and one resource listed. The template name specified in the intent node and the at least one template name specified in the intent node are determined. A template that exhibits the template name and has capabilities to process the at least one resource in the intent note is selected. The selected template is inserted into the tree structure of the job ticket such that it is subordinated to the respective intent node.

### BACKGROUND

The preferred embodiment concerns a method, a computer program and a system for automatic execution of a job ticket for a printing process.

In “Das Druckerbuch, Technik und Technologien der OPS-Hochleistungsdrucker”, Edition 5a, October 2000 (ISBN 3-00-001019-X), an order distribution system (which is also designated as a workflow manager) is described in chapter 14. The entire digital printing process (which comprises a printing pre-stage, a high-capacity printer and an end processing) can be controlled with this order distribution system. In the printing pre-stage image and text files can be consolidated from different sources (such as scanners, digital cameras, data media or a computer network) and brought into their final form at a layout station. A printer driver subsequently converts the data generated at various platforms into, for example, PostScript files. These files can then be relayed to a print server for printing. Print servers convert the data into compressed bitmaps that are imposed entirely automatically and are routed to the printing system. The print server controls the printing process. The end processing of the print product comprises, for example, the binding or insertion of divider sheets.

The order distribution system is moreover responsible for the central administration of the production variants. The printing server for intranet and internet users also belongs to this. The order distribution system informs users about released production variants, accepts print jobs together with digital job pouch, and initiates the automatic execution of the printing. The order distribution system also monitors the correct execution of the selected printing and post-processing options.

Here the order distribution system performs what are known as job tickets. A job ticket is a file that is generated by a user upon generation of the print job in which all specs are provided that are to be executed in the printing process. Conventional job tickets comprise unambiguous instructions that are to be correspondingly implemented.

The printing process becomes increasingly more comprehensive since ever more apparatuses are integrated into a printing process, whereby the functionality increases. Due to the internet and intranet, printing processes are additionally increasingly executed distributed regionally or are associated with a pool of printers that can be regionally distributed. Moreover, apparatuses of different manufacturers must increasingly cooperate in a process. In order to cope with these increased requirements, a unified specification for exchange of data formats in the printing process was agreed upon, which specification is designated as a job definition format (JDF). For this there is a corresponding job messaging format (job messaging formats or JMF) that is correspondingly specified. The specification of JDF can be downloaded from the Internet site www.cip4.org. The current specification at the moment is JDF Specification Release 1.2.

JDF is an XML-based format in which the instructions for the printing process are arranged in a tree structure. Each node (node) of the tree structure comprises an instruction or a set of instructions. The uppermost node is designated as a root. The end nodes at branches are designated as leaf nodes (leaf nodes).

The specialty of JDF lies in that there can be what are known as intent nodes that contain a very general instruction for a printing process that must be rendered more precisely in order to be able to be executed on an apparatus. This more precise rendering, which is also designated as a resolution (resolution), is executed by a corresponding controller in the course of the printing process in that one or more further nodes that render the instruction of the intent node more precisely are subordinate to the intent node. This resolution can occur in steps, meaning that a cascade of further nodes are subordinated to the intent node. This resolution can occur in steps, meaning that a cascade of further nodes are subordinated step by step to an intent node, whereby the exact instructions for the apparatus (in particular the printer) are contained in the last node (the leaf node).

The resolution of the intent instructions into more precise instructions up to the commands contained in the leaf nodes occurs by means of computer programs that are designed similar to device drivers and that convert general intent instructions into more concrete intent instructions or into concrete commands for a printer or an apparatus. Specifications about resources that are contained in the respective nodes are also taken into account in this conversion. According to the JDF specification, all resources are all things that are consumed or produced. They comprise physical objects (such as, for example, paper, ink) or data in the form of files or parameters. A resource has an XML ID with which it is identified in the overall job ticket.

These computer programs for linking of the intent instructions with the resources for resolution of the intent instructions require a great deal of know-how, both about the printing process itself and significant software knowledge. These conversion programs are decisive for whether a printing process can be successfully executed according to the JDF specification or whether there are problems in a printing process given the implementation of the JDF specification.

A method for execution of print jobs in a network is known from EP-A2-1 197 838, given which method it is checked using a job ticket whether a print service provider has the resources required for execution of the print job.

A method for a data processing system arises from US 2002/0080400 A1 in which a document processing job (job) can be processed multiple times in different manners. How the document processing job is executed individually is controlled by different job tickets. The different job tickets are thereby controlled all at once by means of a master job ticket (which is also designated as a super job ticket) such that the plurality of document processing jobs can be input into the data processing system all at once by means of the master job ticket.

A method for editing of job tickets arises from U.S. Pat. No. 5,718,520, in which upon editing of a specific parameter a window on a display device is generated in which all possible values are displayed that can be used for the parameter.

### SUMMARY

It is an object to achieve a method, a computer program and a system for automatic execution of a job ticket for a printing process, with which method, computer program and system a simple implementation of the JDF specification in the printing process is possible.

In a method or program for automatic execution of a job ticket for a printing press, the job ticket with a tree structure is imported in which at least one intent node is contained, the intent node having at least one template name and one resource listed. The template name specified in the intent node and the at least one template name specified in the intent node are determined. A template that exhibits the template name and has capabilities to process the at least one resource in the intent note is selected. The selected template is inserted into the tree structure of the job ticket such that it is subordinated to the respective intent node.

### BRIEF DESCRIPTION OF THE DRAWINGS

FIG. 1 illustrates a system for execution of the method of the preferred embodiment in a block diagram;

FIG. 2 shows the method for resolution of intent instructions in a job ticket by means of a template; and

FIG. 3 illustrates the workflow of the method for selection of a suitable apparatus, in particular of a printer for a printing process.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, and such alterations and further modifications in the illustrated device and such further applications of the principles of the invention as illustrated as would normally occur to one skilled in the art to which the invention relates are included.

The method of the preferred embodiment for automatic execution of a job ticket for a printing process comprises the following steps:

importation of a job ticket with a tree structure in which at least one intent node is contained, in which intent node at least one template name and one resource is listed,

determination of the template name specified in the intent node and the resources listed in the intent node,

selection of a template that exhibits the template name and possesses the capabilities to execute or process the resources specific in the intent node,

insertion of the selected template into the tree structure of the job ticket, whereby it is subordinated to the respective intent node.

The resolution or resolution of job tickets in the JDF format is executed by means of templates with the method of the preferred embodiment. Names are associated with the templates, whereby a name can also be used for a plurality of templates insofar as the templates with the same name differ with regard to the resources. Templates are files that comprise segments of a job ticket, whereby variables can be used instead of values in the segments. Upon insertion of a template, values that originate from a list defined for the job ticket or general specification values (default values) that are independent of the job ticket are used in the variables.

Via the use of templates for resolution of JDF job tickets it is no longer necessary to write special computer programs that convert intent instructions into commands for the apparatuses. Such templates can be generated by anyone who possesses the experience with regard to the printing process; contrarily, he does not require particular software experience since the XML format in which the templates or the job tickets are generated can be learned simply and quickly.

The preferred embodiment is based on the realization that a specific task in the printing process is to be executed via different instructions in the job ticket, dependent on the resources. The corresponding templates are therefore provided for a specific task with the same name, which templates are then automatically selected dependent on the available resources. The problem of the association of precise instructions is thus reduced to a selection dependent on the task (which is defined by the name of the template) and dependent on the available resources. This scheme is very simple and can be realized without particular software knowledge.

The method of the preferred embodiment thus allows a simple implementation of the JDF specification in a printing process.

The method and system of the preferred embodiment are based on the application of the JDF format as it was explained in the preceding. The JDF format as it is known from JDF Specification Release 1.2, as well as the XML code hereby used, are assumed to be known in the subsequent explanation of the preferred embodiment and are not described again. The JDF Specification Release 1.2 is incorporated entirely in terms of content.

A system 1 for execution of the method of the preferred embodiment comprises a network 2 with data lines for exchange of data. This network can be an internet, an intranet, or a local network (LAN) or a supra-regional network (WAN). It can naturally also be a combination of different network types. One or more clients 3 and one or more servers or controllers 4 are connected over this network 2. Apparatuses 5 for execution of specific tasks of the printing process are connected to the servers or controllers 4. These apparatuses 5 are primarily printers 5/1 through 5/6 and apparatuses 5/7, 5/8 for post-processing of the printed media 6 such as, for example, an apparatus 5/7 for punching of holes or an apparatus 5/8 for binding of the printed sheets.

The medium 6 to be printed is normally paper. However, it can also comprise another material such as, for example, films.

The inventive system and the method of the preferred embodiment are primarily provided for printing processes executed with digital electrophotographic high-capacity printers. Such methods are on the one hand significantly more flexible in comparison to the offset printing method, such that they are also suitable for small quantities; on the other hand, in the meanwhile they have also become capable such that they are also suitable for the execution of more elaborate printing processes such as, for example, for generation of books in small editions and the like.

The clients 3 are computers connected at the network 2, on which computers application programs are stored and executed, with which application programs files to be printed are generated. These application programs can be text processing programs, and professional layout programs with which texts and graphics are combined and stored in a file to be printed. Given the use of the JDF format the job ticket and a further file that contains the data to be printed are normally generated. The data of these two files can also be stored in a single file. The result of the printing process is initially defined with the job ticket according to the JDF format. In the further processing of the print job the job ticket is rendered more precisely such that it describes the workflow of the printing process, which is also designated as a workflow. Given use of the JDF format, the result of the printing process is defined at the client 3 in the job ticket with intent instructions. Such intent instructions comprise, for example, only the specification that a book or a newspaper should be printed. The job ticket can naturally also comprise more advanced specifications in the event that they have been established by the user at the client 3.

The job ticket and the data to be printed are relayed to a first server 4/1 via the data network 2. This server distributes the print jobs to specific print centers 7 that respectively comprise one or more printers 5 and a corresponding controller or server 4. A server for printing processes (which is also designated as a print server) is a computer that is suitable to relay print jobs to one or more printers To the contrary, by controller what one understands is a digital control device that is associated with a specific apparatus 5 or a specific printer 5. Both a print server and a controller are equipped with a CPU and data storage for processing of data and can resolve the JDF job ticket. In the following they are therefore designated exclusively as a server 4.

In a first server 4/1 that distributes the print jobs between two print centers 7/1 and 7/2, the job ticket can be resolved in a first stage in that, for example, specific process steps are defined. For example, if a print center comprises only black-and-white printers, the first server 4/1 can further resolve the job ticket to the effect that the print job is to be executed in black-and-white.

The print center 7/1 comprises a server 4/2 and three printers 5/1 through 5/3.

In contrast to this, the print center 7/2 comprises two servers 4/3 and 4/4, whereby the server 4/3 is for controlling three printers 5/4, 5/5 and 5/6 and the server 4/4 is for controlling two post-processing apparatuses 5/7 and 518 for punching or for binding of the printed products.

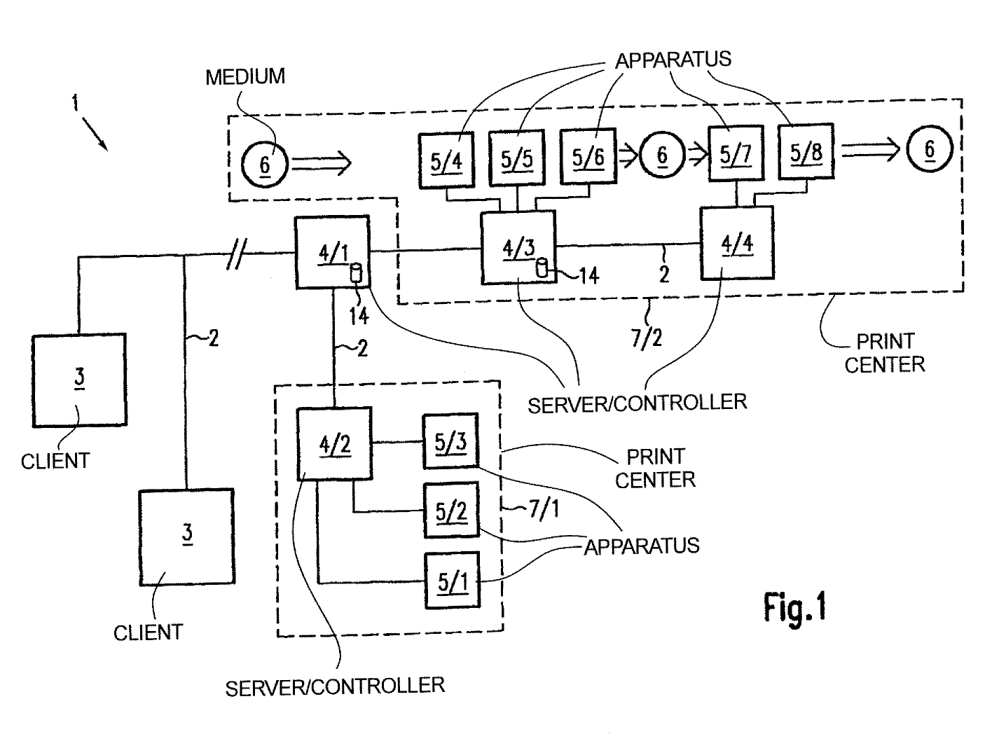

The printing process comprises all steps as they are shown in FIG. 1 in the print center 7/2, beginning with the printing of a medium 6 at one of the printers 5/4 through 5/6 and a post-processing at at least one of the post-processing apparatuses 5/7 or 5/8.

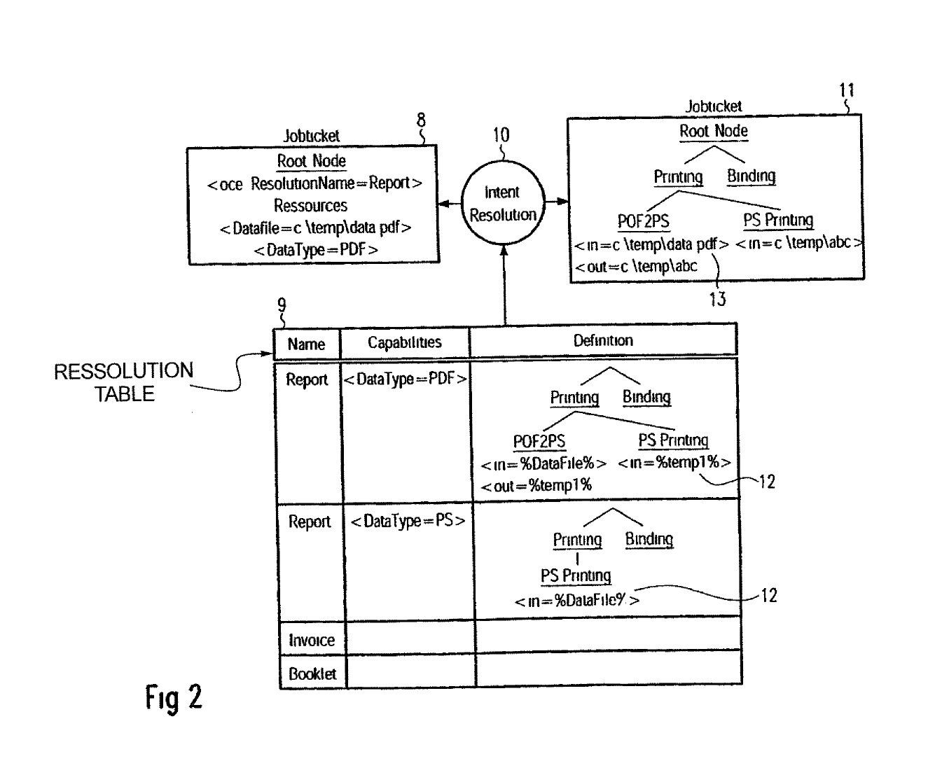

The computer program-controlled resolution of a job ticket with an intent instruction is subsequently exemplarily explained using the scheme shown in FIG. 2.

A job ticket 8 that comprises a root node (root node) is schematically shown in FIG. 2. In this root node it is defined that the data to be printed should be printed as a “report” and it is specified in which file (c:\temp\data.pdf) the data are located and which manner of file type (PDF) this file is. Only the significant excerpts of the definition of such a root node are shown in FIG. 2. For simplification of the representation, the XML format is hereby not followed.

The term “Report” represents a name of a template. How such a report is printed is not defined in the job ticket 8.

If the job ticket 8 reaches one of the servers in which a resolution table 9 is located (which resolution table comprises a series of templates) and if a suitable template is provided, this template is read out (in particular automatically as controlled by a program) and subordinated to the root node. This step is designated as intent resolution 10.

The selection of the template occurs on the one hand dependent on the name of the template (which, in the present exemplary embodiment, reads “Report”) specified in the intent instruction. A further criterion for selection of the template is the resources that are specified in the job ticket 8. For example, the table 9 comprises two templates with the designation “Report” that differ in terms of their capabilities (capabilities). The capabilities are a characteristic of the template that correspond to the resources of the job ticket. The resolution table 9 comprises a template “Report” with the capability to process PDF files and a further template with the designation “Report” with the capability to process PostScript files. The job ticket 8 comprises as a resource the data type PDF, which is why the template “Report” for the data type PDF is selected from the table 9. The definition of this template is read out and inserted into the job ticket, whereby the definition of the template is subordinated to the root node of the tree structure. A further-resolved job ticket 11 thus results.

Given insertion of the definition of a template into a job ticket, variables 12 comprised in the template are replaced by corresponding values 13. These values can on the one hand be extracted from the resources specified in the job ticket 8; on the other hand, they can be contained in a list generated for a specific job ticket or be replaced by predetermined specification values (default values) that are stored independent of the job ticket at the server 4 that executes the resolution. At least one part of the instructions of the template is hereby made executable.

With this exemplary embodiment two nodes Printing or Binding are directly subordinated to the root node. Two further nodes, namely PDF2PS and PS printing, are subordinated to the node Printing. The node PDF2PS means that a PDF file is converted into a PostScript (PS) file. The corresponding input and output files are specified. In the job ticket 11 the nodes PDF2PS and PS printing represent leaf nodes of the tree structure since they can be executed directly at a server (PDF2PS) or at a controller of a printer (PS printing).

The insertion of a single template into a job ticket is shown using this example. Not merely one template but rather a plurality of templates are typically inserted into a job ticket. This means that a general intent instruction is increasingly rendered more concretely via the addition of further nodes. As is also the case in the present example, a template can itself comprise a plurality of nodes. The resolution of the intent instructions in concrete commands for control of a printer can also occur in steps distributed over a plurality of servers.

For the preferred embodiment it is essential that the resolution of intent instructions occurs via insertion of templates that are selected based on their name and their capabilities. All sub-processes of a printing process can be comprised with this scheme since the individual sub-processes are respectively provided for completion of a specific task and depend on the available resources. These resources can hereby be files or properties of files, but also objects or properties of objects such as, for example, paper or the format of paper.

If the resource changes, a different template is to be selected. For example, if the job ticket 8 in FIG. 2 were to contain PS (for the PostScript format) as a file type, the further template with the designation “Report” in which the data are printed directly would have to be selected since they already exist in the PostScript format and no longer have to be converted from a PDF format into a PostScript format.

This scheme of the template can be reconstructed very simply without particular software knowledge. Insofar as he possesses basic knowledge of the XML format, a user can thus define his own template. High-capacity printing systems are typically attended by personnel who possess such basic knowledge. An editor for editing of the template is therefore also advantageously provided.

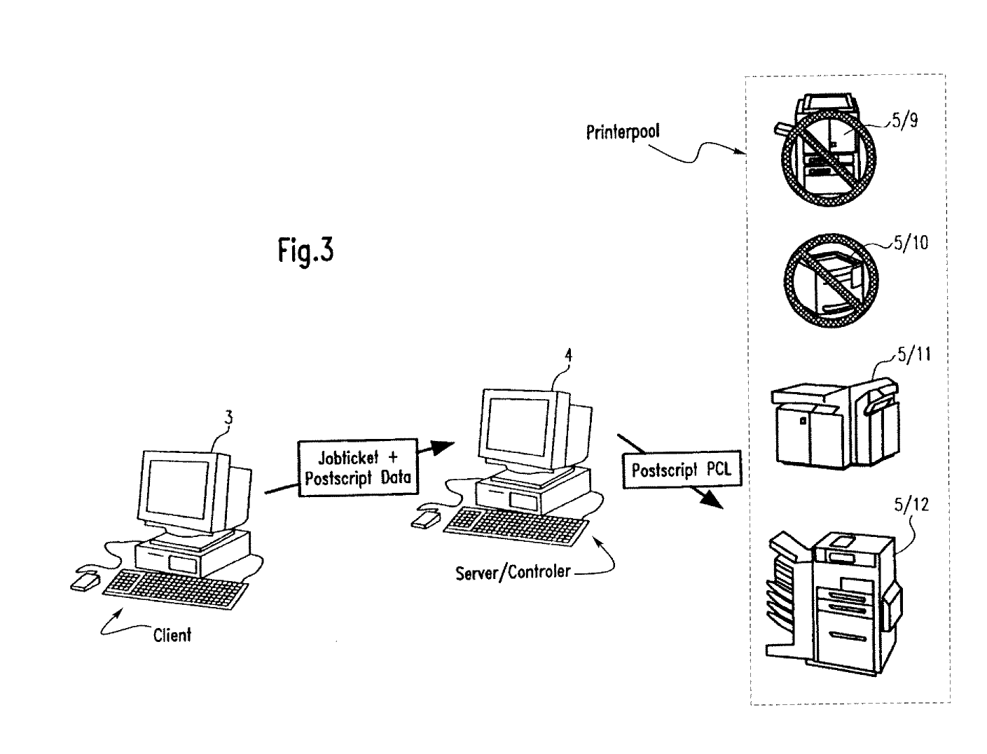

The association of a specific print job with an apparatus (in particular with a printer) is subsequently exemplarily explained using the scheme shown in FIG. 3.

A print job is generated at a client 3 and normally comprises (as is explained above using FIG. 1) a job ticket and a further file that comprises the data to be printed. The job ticket corresponds to the JDF format.

The print jobs are respectively associated with one of a plurality of apparatuses at the server 4. A printer pool with four printers 5/9 through 5112 is schematically shown in FIG. 3.

In the preferred embodiment the print jobs are distributed by the server 4 according to two criteria: the capabilities (capabilities) and the affinities (affinities).

The criterion of the capabilities corresponds to the JDF format.

Features of the print job are hereby compared with capabilities of the individual printers. These capabilities are stored on the server in the form of lists associated with the respective printers. Typical capabilities that are taken into account in this comparison are:

Auto-Routing Enabled

The capability “auto-routing” must be active at the printer; otherwise the printer cannot accept a print job automatically relayed from the server.

Color

The printer is normally designed either for single-color printing (monochrome) or multi-colored printing (CMYK).

Duplexing

The printer can be set for one or more duplex modes. For example, 20 one-sided printing, two-sided printing fall under this. There are a series of modifications of this in which the edges, the arrangement of the print image on the paper and the like can be processed differently.

Side Switching Enabled

The print order is changed with side switching such that the back side is printed first. This is appropriate given some applications such as, for example, duplex printing.

Allowed User

At the apparatus the capability must be set that a user can use this apparatus so that a print job from this user can be processed at this apparatus.

Page Threshold

At some apparatuses a page threshold is predetermined that establishes the range of the pages to be printed of a single print job. In the comparison of the capabilities the number of the pages of the document to be printed is multiplied at the print server 4 with the number of the copies of the document to be printed and the product resulting from this must lie inside the predetermined range.

Media

The print medium requested with the print job must be supported by the apparatus and be present at or capable of being supplied to this apparatus.

Advanced Paper Handling (APH) Enabled

In the event that, for example, a change of the print medium or a printing of a binding is required in the print job, it is then necessary that the capability “advanced paper handling (APH)” is active.

Mailbox

Given some print jobs it is necessary that a mailbox is activated so that, for example, the print job can only be resolved at the printer via input of a specific password.

In the event that it is established at the server 4 that none of the apparatuses fulfills the capabilities required by the print job, the print job must be rejected by the server 4 as non-executable.

In the event that a single apparatus satisfies all capabilities required by the print job, the print job is assigned to this apparatus by the server 4. The corresponding files are hereby converted at the server 4 into a bitmap file and transferred to the printer that then executes the printing process corresponding to the bitmap file, or the print job is transferred in the form of the job ticket and the corresponding data file to the printer at which the bitmap file is generated from these data by means of a controller for control of the printing process. If the job ticket is transferred from the server 4 to the printer 5, it is further resolved on the server 4 in that a node for execution of the print job is entered into the job ticket on this server.

However, in the event of a plurality of apparatuses that satisfy the necessary capabilities, the criterion of the affinities is taken into account with the present preferred embodiment.

In the example schematically shown in FIG. 3, the printers 5/9 and 5/10 do not fulfill the required capabilities. The printers 5/11 and 5/12 are available for the further selection.

The selection according to affinities differs in principle from the selection according to capabilities. Given the selection according to the criterion of the capabilities, a strong correlation must exist between the required capabilities and the capabilities of a selected printer. To the contrary, given the selection according to the affinities it is attempted to discover the most suitable printer or the most suitable apparatus from a set of suitable apparatuses. Affinities desired by the print job are hereby compared with affinities offered by the respective printers.

The selection can, for example, occur in that the apparatus that satisfies the most desired affinities is selected. However, the individual affinities can also be weighted with a weighting factor that is greater the more important that the respective affinity is for the selection of the apparatus. The apparatus is hereby selected that exhibits the affinities required by the print job with the greatest weighting factor in total.

The comparison of the affinities can also occur in that the affinities are checked in a specific order, whereby all suitable apparatuses are taken into account given a check of a respective affinity. If an advantage for one apparatus relative to all other suitable apparatuses arises given an affinity, this apparatus is selected and the check of the further affinities is no longer executed. Given this method the order of the affinities is important. The important affinities are checked first and the less important affinities are checked at the end.

Some examples for affinities are listed in the following:

APH Inserts/Unprinted Covers

The number of the divider sheets and unprinted covers that the apparatus can generate is calculated. The apparatus with the greatest number is preferred as necessary.

Finishing

There are a plurality of processing steps that the apparatus can execute. The apparatus that can execute the greatest number of the processing steps desired by the print job is preferred. Examples for such processing steps are:
stacking of the printed sheets: there are a plurality of variants of how the printed sheets can be stacked.
binding: there are a plurality of variants of how a printout can be bound (thread binding, glue binding)
collating: it is checked whether the apparatus allows collating.
punching: here it is checked whether the apparatus can punch holes.
folding: here it is checked whether the apparatus can effect a desired folding.
   Preferred Device

A specific apparatus can be specified as a preferred apparatus in a print job. This is checked with this affinity. If a weighting of affinities exists, this affinity is to be weighted very high since it corresponds to the explicit desire of the generator of the print job.

With the affinity of the apparatus availability it is checked whether the apparatus is located in an “idle cycle” (idle) or whether it is “in operation” (running). An apparatus located in an idle cycle is preferred.

Speed

The apparatus with the highest processing speed is preferred.

Least Recently Used

The apparatus that has not been used for the longest time is preferred.

Given the presence of a plurality of equivalent apparatuses, a uniform distribution of the print jobs to the apparatuses is hereby effected.

If a specific apparatus is selected, a further node in the job ticket is generated that is a leaf node; this means that it can be directly executed at the apparatus.

There is no specific association to the effect that a specific feature is to be checked as a capability or as an affinity. Rather, it is also possible to also consider in the check of the affinities specific features that are considered in the check of the capabilities. According to the JDF format, features that are considered in the check of the capabilities must be compared with the resources specified in the job ticket. To the contrary, the affinities are features of each arbitrary property of the job ticket and do not have to be limited to features of the resources.

The selection of an apparatus according to affinities as it is described above allows the determination of the most suitable apparatus in a complex printing process, whereby the determination must only occur at a print server that can be directly upstream of the printers in the process chain.

Given conventional methods the apparatus is selected either by the generator of the print job or manually by an operator of a print server.

With the preferred embodiment the selection of the most suitable apparatus occurs on the one hand automatically and on the other hand significantly faster whereby a plurality of selection parameters (meaning a plurality of affinities) can also be considered. This represents a significant increase of the quality of the workflow of the printing process.

This in particular applies in connection with print jobs according to the JDF format, in which intent instructions are contained in the job ticket. Since these intent instructions are very non-specific, it can also initially be left completely open which apparatus is most suitable for execution of the print job. The necessary capabilities are only defined in detail in the course of the resolution. However, a selection solely according to the capabilities is not always optimal with regard to costs, speeds, economy and quality of the print product. With the additional selection according to affinities, the print process can automatically be optimized with regard to costs, speed, economy and quality of the printing process so that with such a JDF printing process it is possible to keep the print job optimally non-specific at the beginning of the generation of the same and nevertheless to execute with an optimized apparatus selection that is initially not established.

A preferred method for updating of the lists of the features (for example capabilities, affinities) of an apparatus that are stored in a server is subsequently explained.

According to the JDF format, the current features of the apparatus are transmitted upon a specific query (“KnownDevices”) by a server to an apparatus, whereby a complete list of all features is always transferred.

In the preferred method a server or a software running on the server can alter the query to the effect that only changes of the features of the apparatus (delta messages) are transferred. Upon such a query the complete list of the features is initially transferred once from the apparatus to the server and only the changed features of the descriptive data are subsequently transferred given changes.

A mixed transfer of the data can also be requested, whereby every N-th message comprises the complete list of the features and all further messages merely comprise the changed features of the apparatus. This mixed transfer is preferred when the server should be synchronized with the connected apparatuses at regular intervals. For the automatic selection of an apparatus according to the criteria of the capabilities or the affinities it is necessary that the corresponding lists of the features of the apparatuses are current. The data volume to be transferred can be limited with the method of the transfer of messages that merely comprise data of the changed features (delta messages). That is very advantageous given a large branched printing system in which a more intensive exchange of data exists in principle.

A preferred embodiment of the server 4 (FIG. 1) is subsequently explained according to which a storage space 14 associated with a client is set up on one of the servers 4. This storage space is subsequently designated as a client storage space 14.

The print servers 4 exhibit powerful functions for processing of documents to be printed. They can thus sometimes convert from arbitrary print data streams (for example AFT, PCL, PPDS, AFPDS, IPDS) into graphical files of other formats such as, for example, the PDF format. These conversion functions are provided in order to convert the data received with the print data stream into a format suitable for the respective printer. Some of these print formats are very printer-specific. However, there are also formats that are used not only for printing at the printer but rather also can be used otherwise. At the client 3 an interface is provided to the user, with which interface the user can access the client storage space 14 at one of the servers 4 and therewith can access the print data in the converted formats.

A program packet is associated with the client storage space 14 at the respective server 4, in which program packet the following functions can be executed:

View

The document stored in the client storage space 14 can be viewed with the function “view”. With this function the print job can be monitored before it is printed out. In connection with the use of the JDF format this is very advantageous since how the original, not very precisely defined JDF job ticket has been resolved and the print data have been accordingly converted can be monitored with this.

E-Mail

The document can be sent with the function “e-mail”.

Send to Archiving

The function “send to archiving” allows the document to be transmitted to an archiving system.

Follow-Me

The function “follow-me” allows a print job to be stored in the client storage space 14, whereby the print job has been output to one of the clients 3. The user can then retrieve this print job from a further client, a server or even the printer (insofar as this comprises corresponding input means) itself at any later point in time and be printed out at a printer selected by the user. The selection of the printer hereby occurs only with the retrieval of the print job from the client storage space 14. For the user this function offers the advantage that he does not have to establish the location at which the print file is printed out upon generation of the print job, but rather can have the print job retrieved and printed out there on site at a later point in time when he is, for example, located at a different location.

In this embodiment the interface provided at the client 3 for communication with the server serves for quitting of print jobs, monitoring of the print jobs and for organization of the client storage space 14.

A method for automatic transmission of print jobs from a client to a server is subsequently explained.

In this method local data directories (folders) at the client or an arbitrary location on the network are configured as file folders to be monitored (hot folders). One of the servers 4 can directly access these file folders to be monitored. The server 4 is configured such that it regularly monitors these file folders to be monitored as to whether they comprise a complete print job. A print job comprises a file that exists in a format to be printed (PostScript, PCL, TIFF or PDF) and comprises a JDF job ticket. If such a complete print job is stored in a file folder to be monitored, one of the servers 4 reads out this print job and directs it to the further processing.

Given a modification of this monitoring function, a complete print job of a folder to be monitored does not necessarily have to exist, rather only a file in a printable format. This file is then read by one of the servers 4 and processed further together with a specification JDF job ticket (default job ticket).

The preferred embodiment can be briefly summarized as follows:

The preferred embodiment concerns a method and system for automatic execution of a job ticket for a printing process.

The job ticket corresponds to the JDF format, meaning that it comprises intent instructions that are rendered more concretely in the course of the printing process. The more concrete rendering is designated as resolution.

The preferred embodiment is characterized in that the resolution occurs by means of templates that are selected automatically using their name and the resources listed in the job ticket. In the job ticket the templates are then subordinated to the node that comprises the intent instruction to be resolved. The templates can thus comprise a segment of a tree structure.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

1-22. (canceled)

23. A method for automatic execution of a job ticket for a printing process, comprising the steps of:
importing the job ticket with a tree structure in which at least one intent node is contained, said intent node having at least one template name and one resource listed;
determining the at least one template name specified in the intent node and the at least one resource listed in the intent node;
selecting a template that exhibits the template name and has capabilities to process the at least one resource in the intent node; and
inserting the selected template into the tree structure of the job ticket such that it is subordinated to the respective intent node.

24. A method according to claim 23 wherein the template comprises one or more variables that are automatically replaced by a value upon insertion of the template into the job ticket.

25. A method according to claim 24 wherein the value is extracted from one of the resources specified in the job ticket.

26. A method according to claim 24 wherein the value is extracted from a predetermined list of values that was generated in advance for said job ticket, or a predetermined default value that is stored independent of the job ticket is used as a value.

27. A method according to claim 23 wherein print jobs are distributed to apparatuses by a server dependent on two criteria, comprising capabilities and affinities, said print jobs being executed at said apparatuses.

28. A method according to claim 27 wherein the criterion of the capabilities is checked as to whether the selectable apparatuses possess all capabilities in order to be able to execute a specific print job.

29. A method according to claim 27 wherein the affinities of the selectable apparatuses and of the print jobs are compared, whereby affinities are on the one hand properties of the apparatuses and corresponding features of the print jobs, an apparatus being selected that exhibits an advantage relative to all other suitable apparatuses with regard to the affinities.

30. A method according to claim 29 wherein the affinities are checked in a specific order, whereby given a check of a respective affinity all suitable apparatuses are considered, and if an advantage for one apparatus relative to all other suitable apparatuses results in the check for a specific affinity said apparatus is selected and the check of further affinities is no longer executed.

31. A method according to claim 29 wherein the apparatus that fulfills the most affinities desired by the print job is selected.

32. A method according to claim 29 wherein the affinities are weighted corresponding to their importance, and an apparatus is selected that exhibits affinities required by the print job with a greatest weighting factor in total.

33. A method according to claim 27 wherein lists of features of apparatuses that are connected with the server are stored, and the lists are regularly updated in that only changes of a respective apparatus are transferred.

34. A method according to claim 33 wherein complete lists of the features are transferred from the respective apparatus to the server at regular intervals, and in between said intervals only changes of the features of the respective apparatus are transferred from the apparatus to the server.

35. A method according to claim 23 wherein local file folders are configured at a client or an arbitrary location on a network as file folders to be monitored and a server monitors these file folders as to whether a document processing job is present, and when this is the case reads out this document processing job and automatically passes it to further processing.

36. A method according to claim 35 wherein a print job is only read out when it comprises both a file containing data to be printed and a corresponding job ticket.

37. A method according to claim 35 wherein each file is read out in a printable format and is supplied with an advance job ticket to the further processing.

38. A method according to claim 23 wherein the capability to process comprises the capability to execute the at least one resource.

39. A system for automatic execution of a job ticket for a printing process, comprising:
a network via which at least one of at least one client, at least one server, or at least one controller with at least one apparatus for execution of a printing process are connected; and
the at least one server or at least one controller having a computer readable medium comprising a computer program that performs the steps of
importing the job ticket with a tree structure in which at least one intent node is contained, said intent node having at least one template name and one resource listed,
determining the at least one template name specified in the intent node and the at least one resource listed in the intent node,
selecting a template that exhibits the template name and has capabilities to process the at least one resource in the intent node, and
inserting the selected template into the tree structure of the job ticket such that it is subordinated to the respective intent node.

40. A system according to claim 39 wherein the apparatuses comprise at least one electrophotographic printer.

41. A system according to claim 39 wherein a client storage space is set up on the server on controller, said client storage space serving for storage of print documents converted into a print format and which are accessible by the client by an interface.

42. A system according to claim 41 wherein at least one of the functions, viewing a document, sending document via e-mail, transmitting a document to an archiving system, or buffering a document for a later printout are associated with the client storage space.

43. A system according to claim 42 wherein the function for buffering of a print job is designed such that the print job can be retrieved from any point on the network, and a printer at which it is to be printed out can thus be selected.

44. A system according to claim 39 wherein the capability to process comprises the capability to execute the at least one resource.

45. A computer-readable medium comprising a computer program that performs the steps of:
importing the job ticket with a tree structure in which at least one intent node is contained, said intent node having at least one template name and one resource listed;
determining the at least one template name specified in the intent node and the at least one resource listed in the intent node,
selecting a template that exhibits the template name and has capabilities to process the at least one resource in the intent node; and
inserting the selected template into the tree structure of the job ticket such that it is subordinated to the respective intent node.

46. The medium of claim 45 wherein the program step of having the capability to process comprises the capability to execute the at least one resource.
